(19) United States
(12) Patent Application Publication
(10) Pub. No.: US 2015/0065722 A1
(43) Pub. Date: Mar. 5, 2015

(54) FUSED THIOPHENE DITIN MONOMERS

(71) Applicant: Corning Incorporated, Corning, NY (US)

(72) Inventors: Mingqian He, Horseheads, NY (US); James Robert Matthews, Painted Post, NY (US); Weijun Niu, Painted Post, NY (US); Arthur Lawrence Wallace, Corning, NY (US)

(21) Appl. No.: 14/477,121

(22) Filed: Sep. 4, 2014

Related U.S. Application Data
(60) Provisional application No. 61/874,028, filed on Sep. 5, 2013.

(51) Int. Cl. C07F 7/22; C08G 61/12; B01J 31/24

(52) U.S. Cl. CPC C07F 7/2212; B01J 31/24; C08G 61/126; C08G 61/124; B01J 2531/824; B01J 2231/40; C08G 2261/12; C08G 2261/18; C08G 2261/3243; C08G 2261/3241; C08G 2261/3223
USPC 548/103; 549/3

(57) ABSTRACT

The disclosure relates to thiophene-based ditin compounds and methods of making and using such compounds. The disclosed compounds are novel structures having organotin groups on a conjugated aryl group spaced from and adjacent to a fused thiophene moiety. The formation of trialkyl tin groups spaced away from the fused thiophene moieties is advantageous in that it allows for novel polymerization via Stille coupling.

### CROSS REFERENCES TO RELATED APPLICATIONS

This application claims the benefit of priority under 35 U.S.C. §119 to U.S. Provisional Application Ser. No. 61/874,028, filed on Sep. 5, 2013 the content of all of which is relied upon and incorporated herein by reference in its entirety.

### FIELD

The disclosure relates to thiophene-based ditin compounds and polymers and methods of using such compounds.

### BACKGROUND

Recently, highly conjugated polymers have been the focus of academic and industrial research, mainly due to their interesting electronic and optoelectronic properties. Among them, Corning's patented fused thiophene polymers are prominent promising candidates. These have previously been synthesized by Stille Coupling. In 2010, synthetic methods for forming a series of β-, β′-alkyl substituted fused thiophene ditin monomer materials were reported (Scheme 1) (U.S. Pat. No. 8,278,346, hereby incorporated by reference in its entirety).

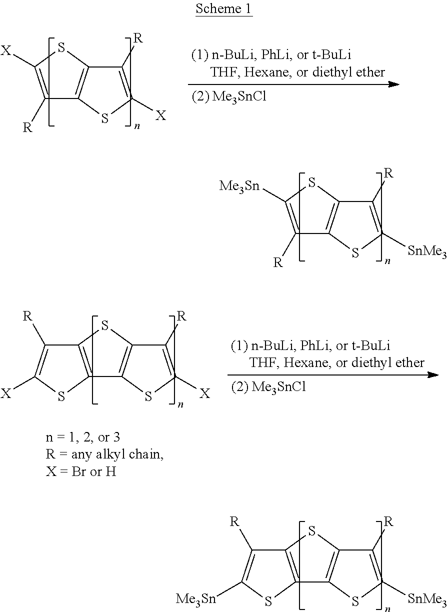

Scheme 1: β-, β′-alkyl substituted fused thiophene ditin monomers.

These β, β′-alkyl substituted fused thiophene ditin monomer materials, abbreviated as DSnDCxFTx (DSn=ditin groups where R³ is alkyl; FTx=fused thiophene having x thiophene groups; DCx=β-, β′-alkyl substituents of x length), for example:

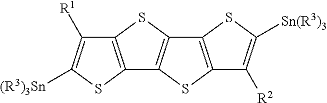

where FTx=FT4; DSn=Sn(R³)₃; and the β-, β′-alkyl substituents are R, may be used in a number of reaction schemes, including as monomers to synthesize semiconducting polymer for use in OTFTs. Such polymers have shown world-class device performance (Scheme 2) (U.S. Appl. Nos. 61/553,326, 61/553,331, Ser. No. 13/655,055, and Ser. No. 13/660,529, all of which are hereby incorporated by reference in their entireties).

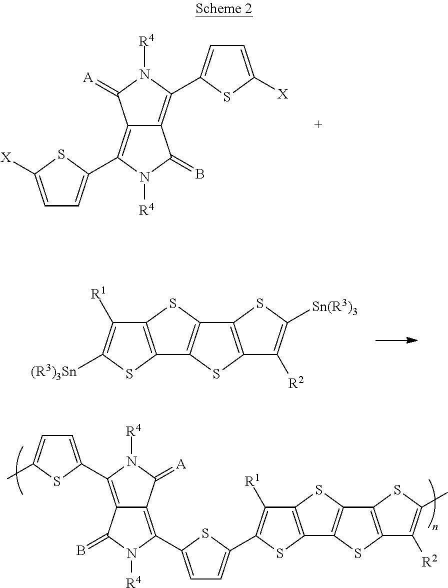

Scheme 2: DSnDCxFT4, a co-monomer in the Stille coupling synthesis of one of Corning's semi-conducting polymeric materials.

Ongoing research is directed to the unmet need of new and improved synthetic processes. To this end, new chemistry has been developed to produce monomers for use in organic semiconductor polymers.

### SUMMARY

A first aspect comprises a compound of formula (I) or (II):

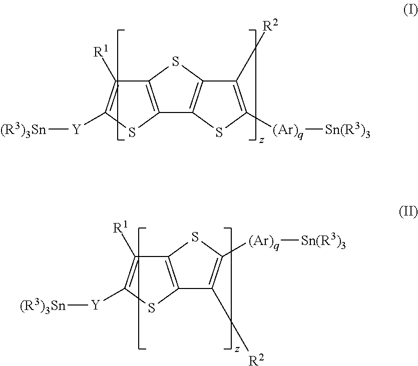

wherein z is an integer from 1 to 5; each q is independently an integer from 1 to 10; R¹ and R² are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; each R³ is, independently, hydrogen or substituted or unsubstituted C₁-C₁₀ alkyl; each Ar is independently an aryl or heteroaryl group; and Y is (Ar)_{q} or is a bond between the fused thiophene and the Sn moiety.

In some embodiments, z is an integer from 2 to 4. In some embodiments, R¹ and R² are, independently, substituted or unsubstituted alkyl, substituted or unsubstituted alkenyl, substituted or unsubstituted alkynyl. In some embodiments, both R₁ and R₂ are an optionally substituted alkyl group comprising at least four carbon atoms. In still other embodiments, each R³ is, independently, an unsubstituted C₁-C₁₀ alkyl. In some compositions Y is (Ar)_{q}. In other compositions each Ar is independently selected from the group consisting of azoles, thiazole, benzothiophene, pyrrole, furan, or:

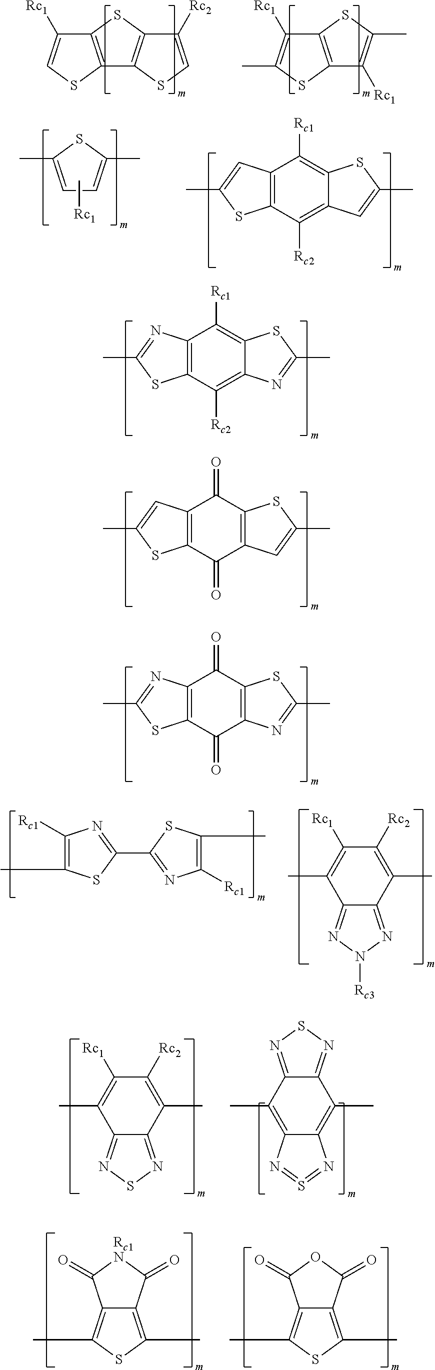

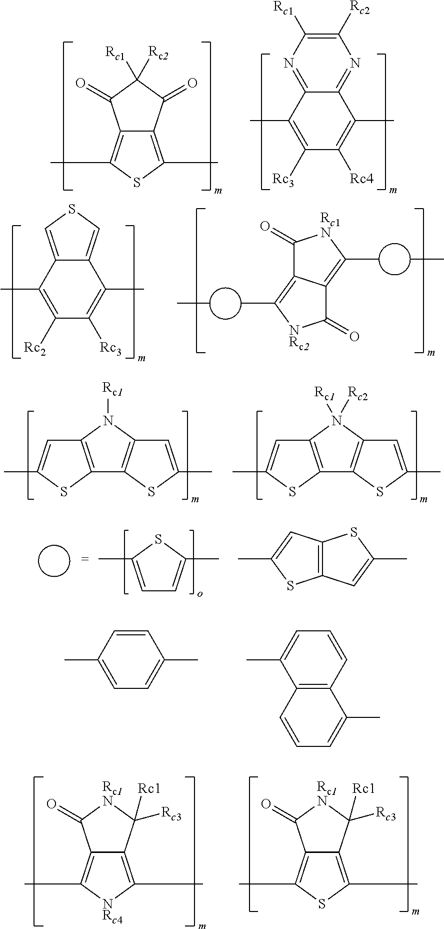

wherein each m is independently is 1, 2, or 3; o is 0, 1, 2, or 3; R_{c1}, R_{c2}, R_{c3}, and R_{c4} are independently H, halo, optionally substituted C₁-C₄₀ alkyl, optionally substituted aralkyl, alkoxy, alkylthio, optionally substituted C₂-C₄₀ alkenyl, optionally substituted C₂-C₄₀ alkynyl, amino carbonyl, acylamino, acyloxy, optionally substituted aryl, aryloxy, optionally substituted amino, carboxyalkyl, optionally substituted cycloalkyl, optionally substituted cycloalkenyl, halo, acyl, optionally substituted heteroaryl, optionally substituted heteroaralkyl, heteroaryloxy, optionally substituted heterocyclyl, thiol, alkylthio, heteroarylthiol, optionally substituted sulfoxide, or optionally substituted sulfone. In some embodiments, Ar is an optionally substituted thiophene, fused thiophene, or phenyl group.

In some embodiments of this aspect, each Ar independently comprises one or more optionally substituted unfused thiophene groups, one or more optionally substituted fused thiophene groups, a combination of optionally substituted unfused and fused thiophene groups, or

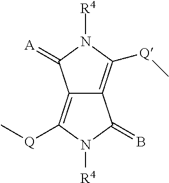

wherein X and Y are independently, a covalent bond or aryl; R₃ and R₄ are, independently, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; and, A and B are, independently, either S or O.

In another example of this aspect, the composition comprises:

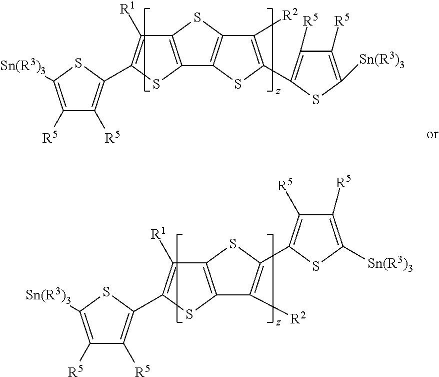

wherein z is an integer from 1 to 5; R¹ and R² are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; each R³ is, independently, hydrogen or substituted or unsubstituted C₁-C₁₀ alkyl; and each R⁵ is, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, vinyl ether, or the two R⁵'s on a single thiophene may form a optionally substituted cycloalkyl, optionally substituted heterocycloalkyl, optionally substituted aryl or optionally substituted heteroaryl.

A second aspect comprises a method of forming a di-tin fused thiophene monomer comprising either:

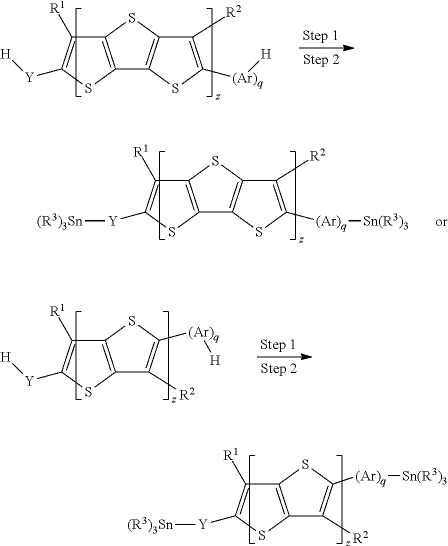

wherein z is an integer from 1 to 5; R¹ and R² are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; and each R³ is, independently, hydrogen or substituted or unsubstituted C₁-C₁₀ alkyl;
comprising:

a) deprotonation of Ar and Y and subsequently,

b) metalization of the Ar and Y groups with an alkyl tin moiety.

In some embodiments of this aspect, the deprotonation step is done via a organolithium compound. In some cases, the lithium compound is a butyllithium, butylmagnesium halide, or butyllithium tetramethylethylenediamine. In some synthetic routes, the metalization step is done via a palladium catalyst and it is possible that some of these palladium catalysts may be metallic palladium, PdX₂, tetrakis(triphenylphosphine)palladium, or PhCH₂Pd(PPh₃)₂X, where Ph is phenyl and X is halo.

In some embodiments of this aspect, both R₁ and R₂ are an optionally substituted alkyl group comprising at least four carbon atoms. In some cases, Y is (Ar)_{q} and/or each Ar is independently selected from the group consisting of azoles, thiazole, benzothiophene, pyrrole, furan, or:

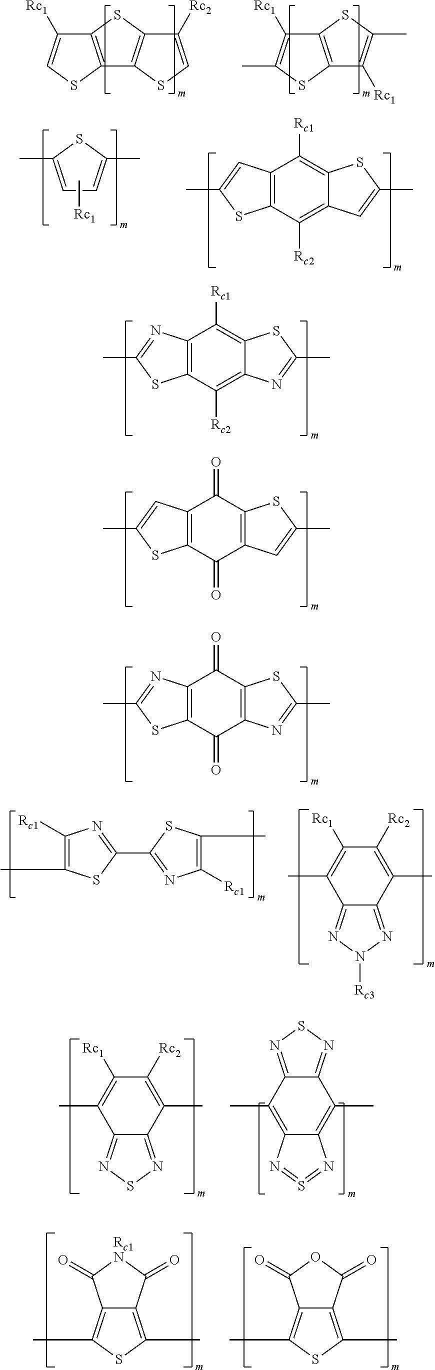

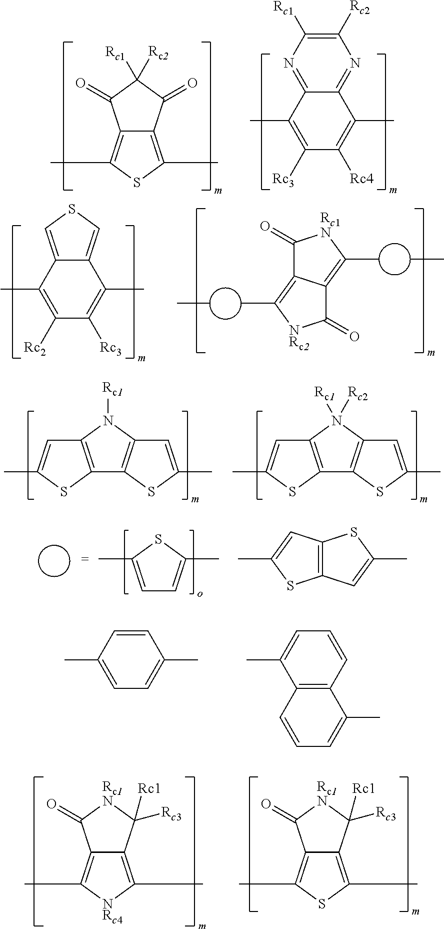

wherein each m is independently is 1, 2, or 3; o is 0, 1, 2, or 3; R_{c1}, R_{c2}, R_{c3}, and R_{c4} are independently H, halo, optionally substituted C₁-C₄₀ alkyl, optionally substituted aralkyl, alkoxy, alkylthio, optionally substituted C₂-C₄₀ alkenyl, optionally substituted C₂-C₄₀ alkynyl, amino carbonyl, acylamino, acyloxy, optionally substituted aryl, aryloxy, optionally substituted amino, carboxyalkyl, optionally substituted cycloalkyl, optionally substituted cycloalkenyl, halo, acyl, optionally substituted heteroaryl, optionally substituted heteroaralkyl, heteroaryloxy, optionally substituted heterocyclyl, thiol, alkylthio, heteroarylthiol, optionally substituted sulfoxide, or optionally substituted sulfone.

In another embodiment of this aspect, each Ar independently comprises one or more optionally substituted unfused thiophene groups, one or more optionally substituted fused thiophene groups, a combination of optionally substituted unfused and fused thiophene groups, or

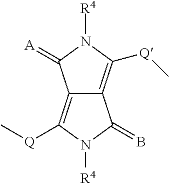

wherein X and Y are independently, a covalent bond or aryl; R₃ and R₄ are, independently, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; and, A and B are, independently, either S or O.

In still another aspect of this embodiment, the composition comprises:

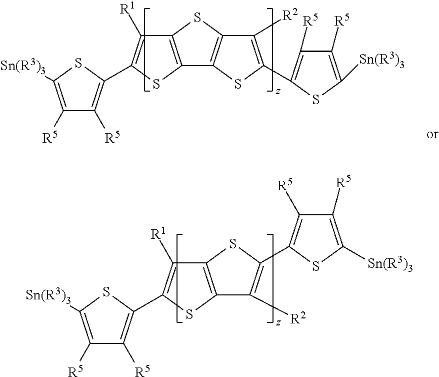

wherein z is an integer from 1 to 5; R¹ and R² are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; each R³ is, independently, hydrogen or substituted or unsubstituted C₁-C₁₀ alkyl; and each R⁵ is, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, vinyl ether, or the two R⁵'s on a single thiophene may form a optionally substituted cycloalkyl, optionally substituted heterocycloalkyl, optionally substituted aryl or optionally substituted heteroaryl.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### DETAILED DESCRIPTION

Before the present materials, articles, and/or methods are disclosed and described, it is to be understood that the aspects described below are not limited to specific compounds, synthetic methods, or uses as such may, of course, vary. It is also to be understood that the terminology used herein is for the purpose of describing particular aspects only and is not intended to be limiting.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

Moreover, where a range of numerical values is recited herein, comprising upper and lower values, unless otherwise stated in specific circumstances, the range is intended to include the endpoints thereof, and all integers and fractions within the range. It is not intended that the scope of the application be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to.

In this specification and in the claims that follow, reference will be made to a number of terms that shall be defined to have the following meanings:

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; more specifically, the phrase “A or B” means “A, B, or both A and B”. Exclusive “or” is designated herein by terms such as “either A or B” and “one of A or B”, for example.

The indefinite articles “a” and “an” are employed to describe elements and components herein. The use of these articles means that one or at least one of these elements or components is present. Although these articles are conventionally employed to signify that the modified noun is a singular noun, as used herein the articles “a” and “an” also include the plural, unless otherwise stated in specific instances. Similarly, the definite article “the”, as used herein, also signifies that the modified noun may be singular or plural, again unless otherwise stated in specific instances.

It is noted that one or more of the claims may utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Throughout this specification, unless the context requires otherwise, the word “comprise,” or variations such as “comprises” or “comprising,” will be understood to imply the inclusion of a stated integer or step or group of integers or steps but not the exclusion of any other integer or step or group of integers or steps.

The term “alkyl group” as used herein is a branched or unbranched saturated hydrocarbon group of 1 to 40 carbon atoms (a smaller range of carbon atoms may be specified herein as “Cx-Cy alkyl” where x and y are integers), such as methyl, ethyl, n-propyl, isopropyl, n-butyl, isobutyl, t-butyl, pentyl, hexyl, heptyl, octyl, decyl, or tetradecyl, and the like. The alkyl group can be substituted or unsubstituted and should be construed as either if not specified. The term “unsubstituted alkyl group” is defined herein as an alkyl group composed of just carbon and hydrogen. The term “substituted alkyl group” is defined herein as an alkyl group with one or more hydrogen atoms substituted with a group including, but not limited to, an aryl group, cycloalkyl group, aralkyl group, an alkenyl group, an alkynyl group, an amino group, an ester, an aldehyde, a hydroxyl group, an alkoxy group, a thiol group, a thioalkyl group, or a halide, an acyl halide, an acrylate, or a vinyl ether. For example, the alkyl groups can be an alkyl hydroxy group, where any of the hydrogen atoms of the alkyl group are substituted with a hydroxyl group.

The term “alkyl group” as defined herein also includes cycloalkyl groups. The term “cycloalkyl group” as used herein is a non-aromatic carbon-based ring composed of at least three carbon atoms, and in some embodiments from three to 20 carbon atoms. Examples of cycloalkyl groups include, but are not limited to, cyclopropyl, cyclobutyl, cyclopentyl, cyclohexyl, etc. The term cycloalkyl group also includes a heterocycloalkyl group, where at least one of the carbon atoms of the ring is substituted with a heteroatom such as, but not limited to, nitrogen, oxygen, sulfur, or phosphorus.

The term “aryl group” as used herein is any carbon-based aromatic group including, but not limited to, benzene, naphthalene, etc. The term “aryl group” also includes “heteroaryl group,” which means an aromatic ring composed of at least three carbon atoms that has at least one heteroatom incorporated within the ring of the aromatic group. Examples of heteroatoms include, but are not limited to, nitrogen, oxygen, sulfur, and phosphorus. The aryl group can be substituted or unsubstituted. The aryl group can be substituted with one or more groups including, but not limited to, alkyl, alkynyl, alkenyl, aryl, halide, nitro, amino, ester, ketone, aldehyde, hydroxy, carboxylic acid, or alkoxy as defined herein. In some embodiments, the term “aryl group” is limited to substituted or unsubstituted aryl and heteroaryl rings having from three to 30 carbon atoms.

The term “aralkyl” as used herein is an aryl group having an alkyl group as defined above attached to the aryl group. An example of an aralkyl group is a benzyl group.

The term “alkenyl group” is defined as a branched or unbranched hydrocarbon group of 2 to 40 carbon atoms and structural formula containing at least one carbon-carbon double bond.

The term “alkynyl group” is defined as a branched or unbranched hydrocarbon group of 2 to 40 carbon atoms and a structural formula containing at least one carbon-carbon triple bond.

The term “conjugated group” is defined as a linear, branched or cyclic group, or combination thereof, in which p-orbitals of the atoms within the group are connected via delocalization of electrons and wherein the structure can be described as containing alternating single and double or triple bonds and may further contain lone pairs, radicals, or carbenium ions. Conjugated cyclic groups may comprise both aromatic and non-aromatic groups, and may comprise polycyclic or heterocyclic groups, such as diketopyrrolopyrrole. Ideally, conjugated groups are bound in such a way as to continue the conjugation between the thiophene moieties they connect. In some embodiments, “conjugated groups” is limited to conjugated groups having three to 30 carbon atoms.

### Compounds

The use of highly conjugated polymers for use in organic electronics has continued to increase in recent years. In particular, polymers based on thiophene-type compounds have shown promising properties as organic semiconducting materials. Because of this, there is a continued interest in finding new inexpensive and safe ways of synthesizing these compounds.

Fused thiophenes, and methods of making fused thiophene-based polymers, have been described in a number of applicants' previous filings, for example, U.S. Pat. Nos. 7,705,108, 7,838,623, 8,389,669, 8,349,998, 7,919,634, 8,278,410, 8,217,183, and 8,278,346, and U.S. Publ. No. 2013/0085256, all of which are incorporated by reference in their entireties. In particular, applicants have shown in U.S. Pat. No. 8,278,346 that it is possible to synthesize a ditin fused-thiophene moiety, such as

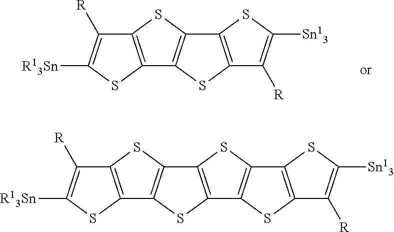

that can subsequently be polymerized to form polymers with improved semiconducting properties. The formation of trialkyl tin groups on the fused thiophene moieties is advantageous in that it allows for simple polymerization via a Stille coupling reaction. However, prior to the current application, no one has shown that it is possible to form the organotin group on a conjugated aryl group spaced from and adjacent to the fused thiophene.

A first aspect provides a new precursor compound of structure (I) or (II):

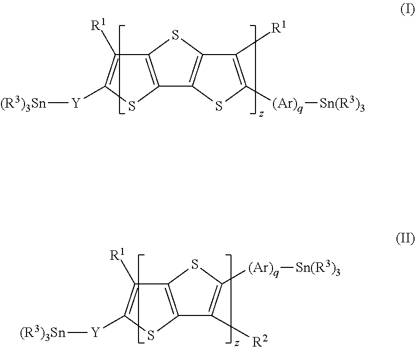

wherein z is an integer from 1 to 5; each q is independently an integer from 1 to 10; R¹ and R² are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; each R³ is, independently, hydrogen or substituted or unsubstituted C₁-C₁₀ alkyl; each Ar is independently an aryl or heteroaryl group; and Y is (Ar)_{q} or is a bond between the fused thiophene and the Sn moiety.

In some embodiments, the compounds described herein can be described by structures (III) and (IV):

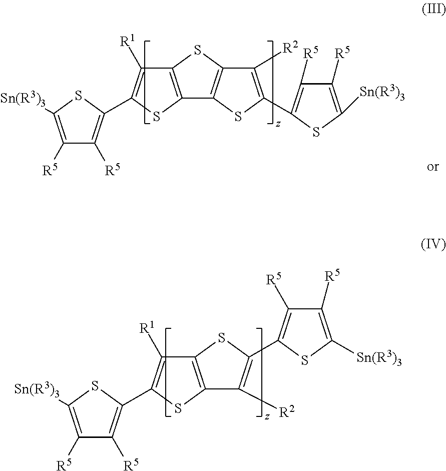

wherein z is an integer from 1 to 5; R¹ and R² are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; each R³ is, independently, hydrogen or substituted or unsubstituted C₁-C₁₀ alkyl; and each R⁵ is, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, vinyl ether, or the two R⁵'s on a single thiophene may form a optionally substituted cycloalkyl, optionally substituted heterocycloalkyl, optionally substituted aryl or optionally substituted heteroaryl.

Embodiments described herein provide a number of advantages over earlier monomers and synthetic processes, including for example, the simplicity or ease with which one can synthetically manipulate or systematically change one or more of the mers or units in the polymer to produce new polymer structures having highly regular or repeat conjugated structure. Plus, the disclosed polymer preparative methods provide additional flexibility or capability to specify the regio-regularity of the polymer structure and additionally, the disclosed methods can be used to make known polymers.

As noted above, the conjugated aryl group, Ar, can generally comprise any aryl or heteroaryl group. For example, one particular group of Ar moieties that are of interest include substituted or unsubstituted thiophenes or fused thiophenes, such as:

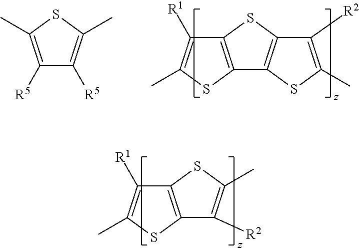

wherein R¹ and R² are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether and each R⁵ on the thiophene groups can individually comprise, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, vinyl ether, or the R⁵s may be linked to the other to form a optionally substituted cycloalkyl, heterocycloalkyl, aryl, or heteroaryl.

A second group of Ar moieties that are of interest comprises substituted or unsubstituted cyclic and polycyclic aryl compounds, such as benzene, naphthylene, anthracene, toluene, pyrene, chrysene, and phenanthrene.

A third group of Ar moieties comprises substituted or unsubstituted cyclic and polycyclic heteroaryl compounds, such as azoles, thiazole, pyrrole, furan, pyridine, pyrimidine, pyrazine, pyridazine, pyran, quinolone, isoquinoline, acridine, phenanthridine, thiopyran, thioquinolone, and isothioquinolilne.

Another group of Ar moieties comprises the group wherein Ar is selected from

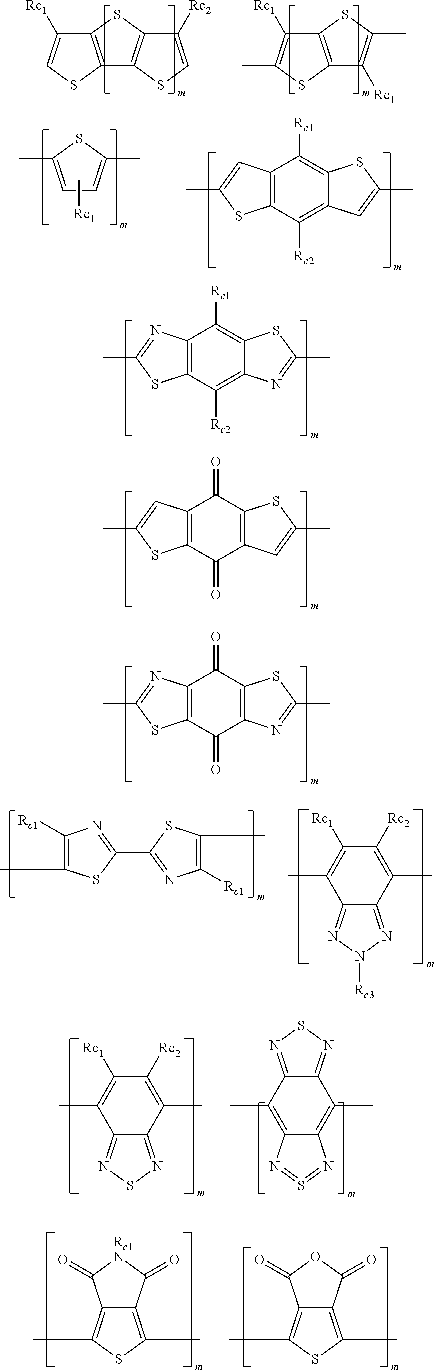

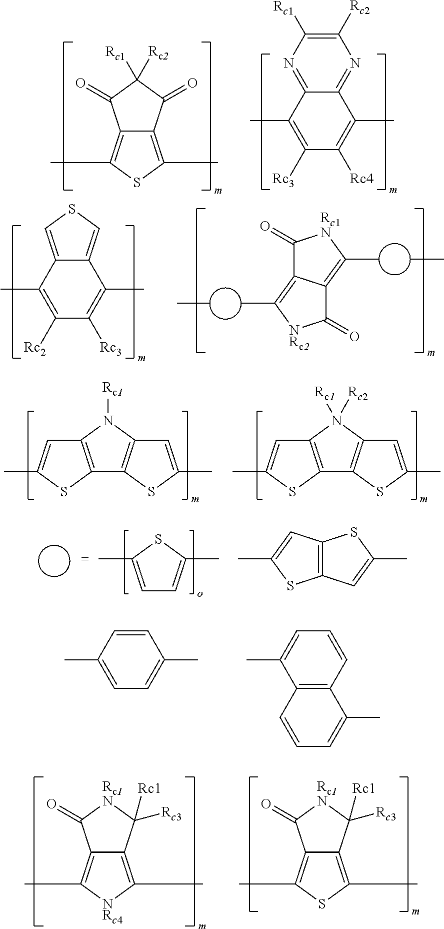

wherein each m is independently is 1, 2, or 3; o is 0, 1, 2, or 3; R_{c1}, R_{c2}, R_{c3}, and R_{c4} are independently H, halo, optionally substituted C₁-C₄₀ alkyl, optionally substituted aralkyl, alkoxy, alkylthio, optionally substituted C₂-C₄₀ alkenyl, optionally substituted C₂-C₄₀ alkynyl, amino carbonyl, acylamino, acyloxy, optionally substituted aryl, aryloxy, optionally substituted amino, carboxyalkyl, optionally substituted cycloalkyl, optionally substituted cycloalkenyl, halo, acyl, optionally substituted heteroaryl, optionally substituted heteroaralkyl, heteroaryloxy, optionally substituted heterocyclyl, thiol, alkylthio, heteroarylthiol, optionally substituted sulfoxide, or optionally substituted sulfone

In some embodiments, Ar is:

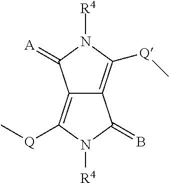

wherein A and B are O or S, each R⁴ is, independently, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether, and Q and Q′ are independently covalent bonds or one or more aryl groups, one of which ultimately links to the fused thiophene moiety.

Generally, the embodied compounds can be made via the reaction shown in Scheme 3:

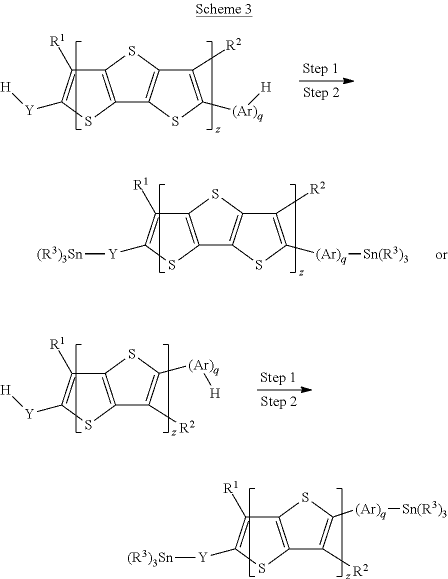

wherein R¹, R², R³, Y, Ar, z, and q are as described above. Step 1 involves deprotonation of the aryl groups with Step 2 metalizing the end groups with an alkyl tin moiety. In particular, the deprotonation step can be done via a organolithium compound, such as a butyllithium, butylmagnesium halide, or butyllithium tetramethylethylenediamine. In particular, t-butyllithium or n-butyllithium may be used.

A specific embodiment of the example reactions shown in Scheme 3 is shown in Scheme 4:

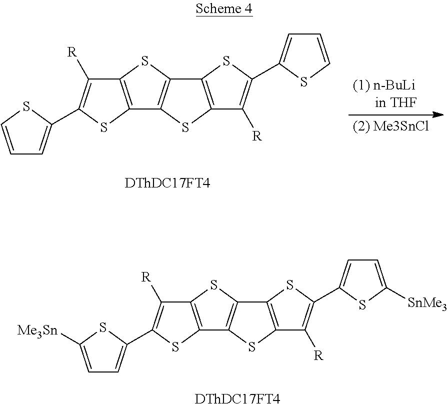

In Scheme 4, a four-ring fused thiophene having C₁₇ linear alkyl groups for each R is reacted with n-BuLi in tetrahydrofuran to form a di-anion that reacts with slightly more than two equivalents of trimethyl tin chloride. The resulting product is obtained in a reasonable yield (71%) after recrystallization.

The direct ditin synthetic route shown in Scheme 3 from the unsubstituted fused thiophene is an important improvement over previous synthetic methods. Many alternative synthetic routes go through a brominated intermediary species (as shown in the Background). However, bromination of many fused thiophene-based compounds, such as the starting material in Scheme 3, does not proceed smoothly. Overbromination is easily done and the resulting by-products are not easily separated from the desired dibromo-species. Direct access to the ditin species allows this issue to be bypassed, improving yield and lowering synthetic costs.

While shown for FT4 and thiophene Ar groups in Scheme 4, the general reaction scheme in Scheme 3 is equally applicable to other FT groups and other Ar groups described herein. Other example embodiments, in addition to those described above and below include thiazole-substitutes fused thiophenes:

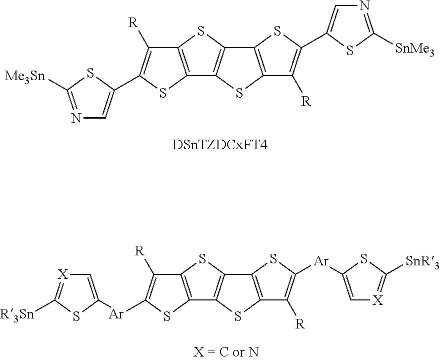

wherein R′ is equivalent to R³ defined above. These new types of monomers have potential applications as the raw materials to synthesize organic semiconductors containing fused thiophene units.

A second advantage to using ditin-based fused thiophene compounds with Ar linkers is that the resulting end products are generally easier to produce. This is because the Ar linker-containing FT moiety is far more soluble that non-linker containing FT moiety. This enables a wider choice of solvents and reaction conditions for the generation of a given desired product, either polymer or extended monomeric species.

Another aspect is the formation of desired compounds and polymers using the ditin species described herein. The resulting ditin compounds can advantageously be coupled to additional moieties via Stille coupling or other reaction schemes. Scheme 5 generically shows how the compounds described herein can be reacted to provide advantageous polymers or multimers:

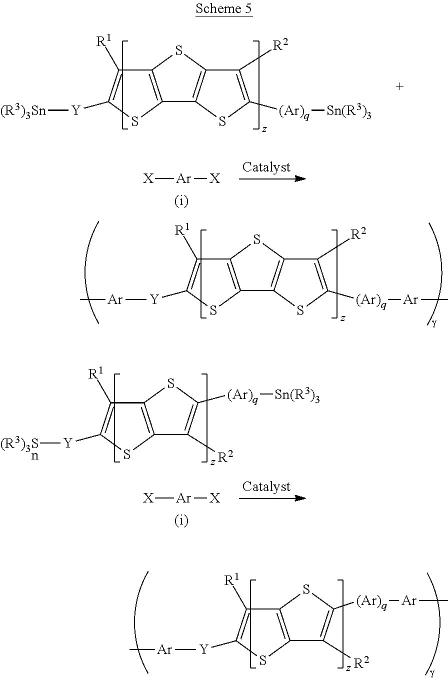

wherein R¹, R², R³, Y, Ar, z, and q are as described above, each X is independently halo or, alternatively, where a non-polymeric product is desired, one of the Xs on the Ar group (i) may be null, and y is an integer from 1 to 1000. A metallic catalyst, such as a palladium-based catalyst can be used in the reaction. The catalyst may include metallic palladium, PdX₂, tetrakis(triphenylphosphine)palladium, or PhCH₂Pd(PPh₃)₂X, where Ph is phenyl and X is halo.

Scheme 6 provides an example wherein the monomer DSnThDC17FT4 is reacted with bromobenzene to produce a diphenyldithiphene four-ring fused thiophene, DPhThDC17FT4 (Scheme 6). In this example, an oligomer DPhThDC17FT4 is obtained as a red solid in 73% yield after flash column chromatography and then a recrystallization. This chemistry can be generalized to the synthesis of other claimed compounds by substituting the proper fused thiophene, end groups, and choosing suitable alternative coupling halides.

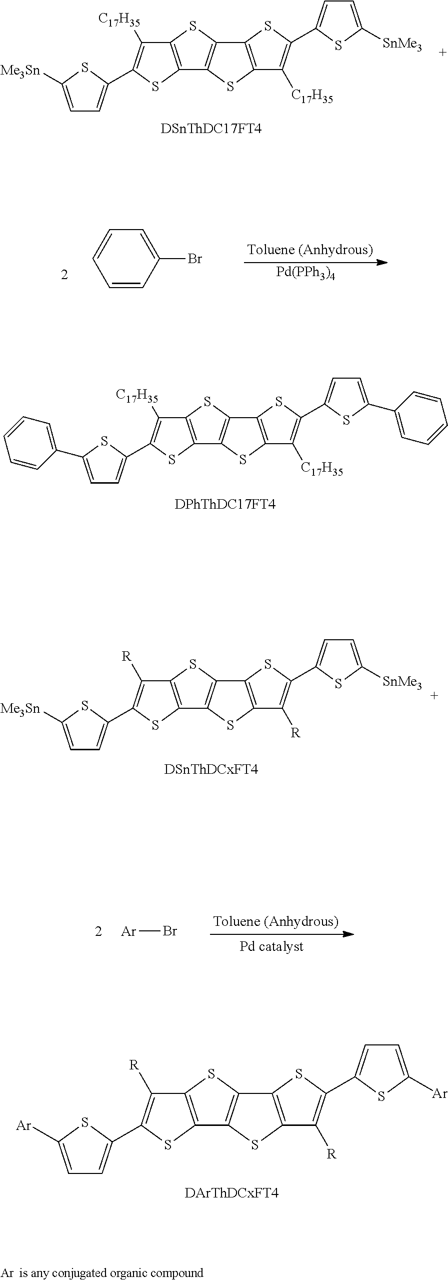

In another example, the monomer DSnThDC17FT4 can be reacted with a dipyrrolopyrrole (DPP) moiety in a Stille coupling to create a polymer containing fused thiophene units linked via two thiophenes to DPP, PC8C10DPPThDC17FT4 (Scheme 7). More generically, the compounds described herein can be reacted with a conjugated aryl moiety, such as a dibromobenzene or other aromatic group, to create the polymer (PArThDCxFT4) shown in Scheme 7.

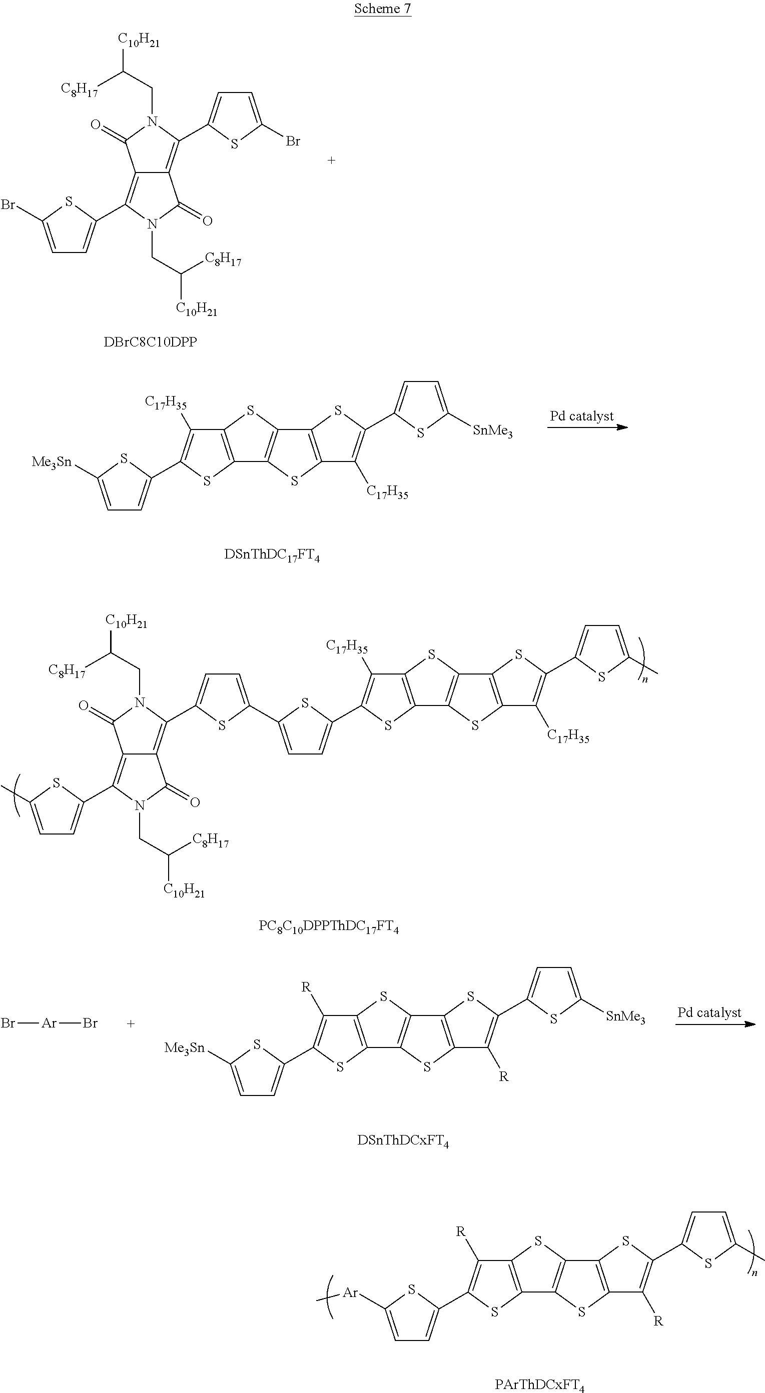

### Examples

### I. Synthesis of DSnThDC17FT4 Monomer

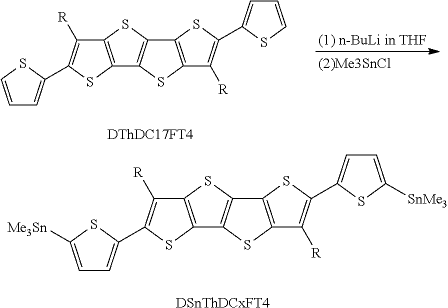

N-BuLi (2.0 M in hexane) (4.6 mL, 9.2 mmol) is added dropwise to DThDC17FT4 (R=C₁₇H₃₅; 2.78 g, 3.11 mmol) in 200 mL of anhydrous THF at −78° C. The resulting solution is allowed to warm to room temperature and stirred for 4 h. It is then cooled to −78° C. and Me₃SnCl solution (1 M in THF) (12.48 mL, 12.48 mmol) is added dropwise. The cloudy reaction solution is allowed to warm to room temperature and stirred overnight. 100 mL of ice-water is added into the cloudy solution and THF is removed under reduced pressure to yield a light yellowish solid in aqueous suspension. The solid is filtered from the aqueous phase and dissolved in ethyl acetate, and washed by water and dried over Na₂SO₄ (anhydrous). After the evaporation of solvent, the residue is recrystallized twice from a mixed solvent system acetone/ethyl acetate (3:1) to form the desired product DSnThDC17FT4 as a light yellow solid (2.69 g, 71%). ¹H NMR (300 MHz, CD₂Cl₂): δ 7.23 (d, J=3.0 Hz, 2H), 7.12 (d, J=3.0 Hz, 2H), 2.86 (t, J=9.0 Hz, 4H), 1.72 (p, J=6.0 Hz, 4H), 1.43-1.09 (m, 56H), 0.80 (t, J=6.0 Hz, 6H), 0.35 (s, 18H).

### II. Synthesis of Oligomer DPhThDC17FT4

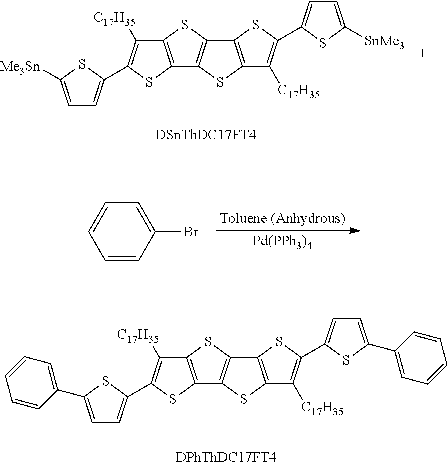

0.26 g (1.62 mmol) of bromobenzene and 15 mL of anhydrous toluene are added to a 35 mL microwave reaction test tube, 0.90 g (0.74 mmol) of DSnThDC17FT4. Under nitrogen protection, 0.13 g (0.11 mmol) of Pd(PPh₃)₄ is added. The reaction tube is sealed and microwaved at 120° C. for one hour. Flash column chromatography using hexane/ethyl acetate/toluene (75:20:5) as the mixed solvent elute is carried out. Solvents from this column are removed to yield a red solid that is recrystallized from toluene to form the desired product DPhThDC17FT4 as a red crystalline solid (0.56 g, 73%). ¹H NMR (300 MHz, CD₂Cl₂): δ 7.62 (d, J=6.0 Hz, 4H), 7.39 (??, J=9.0 Hz, 4H), 7.35-7.06 (m, 6H), 2.96 (t, J=7.5 Hz, 4H), 1.82 (p, J=6.0 Hz, 4H), 1.53-1.18 (m, 56H), 0.86 (t, J=7.5 Hz, 6H).

It will be apparent to those skilled in the art that various modifications and variations can be made without departing from the spirit or scope of the disclosure.

What is claimed is:

1. A compound of formula (I) or (II): 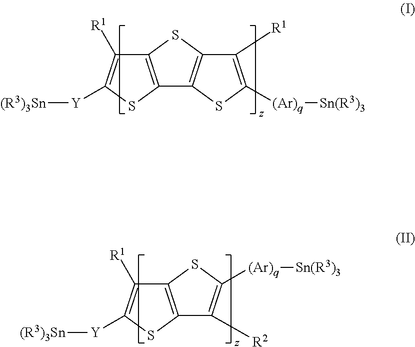
wherein z is an integer from 1 to 5; each q is independently an integer from 1 to 10; R¹ and R² are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; each R³ is, independently, hydrogen or substituted or unsubstituted C₁-C₁₀ alkyl; each Ar is independently an aryl or heteroaryl group; and Y is (Ar)_{q} or is a bond between the fused thiophene and the Sn moiety.

2. The compound of claim 1, wherein z is an integer from 2 to 4.

3. The compound of claim 1, wherein R¹ and R² are, independently, substituted or unsubstituted alkyl, substituted or unsubstituted alkenyl, substituted or unsubstituted alkynyl.

4. The compound of claim 3, wherein both R₁ and R₂ are an optionally substituted alkyl group comprising at least four carbon atoms.

5. The compound of claim 1, wherein each R³ is, independently, an unsubstituted C₁-C₁₀ alkyl.

6. The compound of claim 1, wherein Y is (Ar)_{q}.

7. The compound of claim 1, wherein each Ar is independently selected from the group consisting of azoles, thiazole, benzothiophene, pyrrole, furan, or: 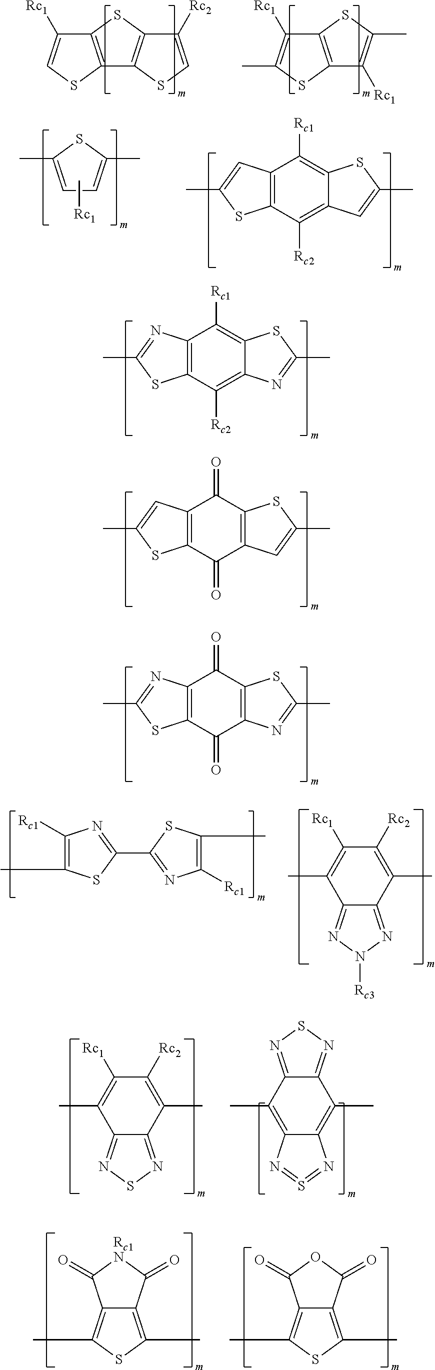 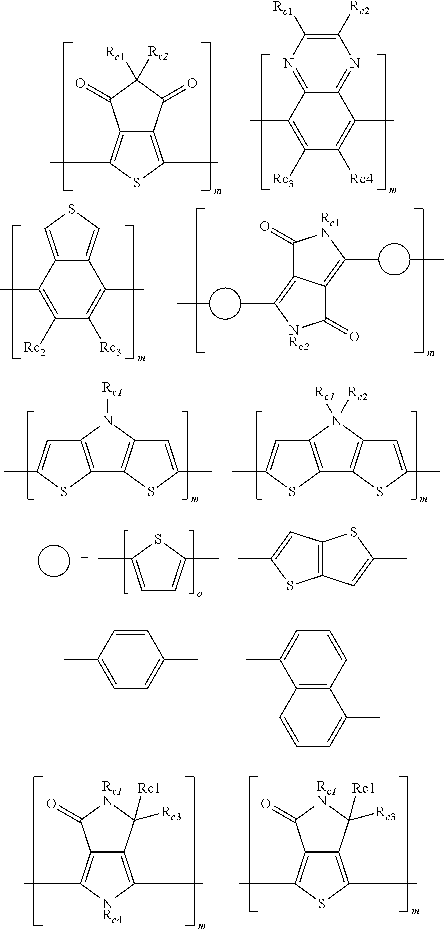
wherein each m is independently is 1, 2, or 3; o is 0, 1, 2, or 3; R_{c1}, R_{c2}, R_{c3}, and R_{c4} are independently H, halo, optionally substituted C₁-C₄₀ alkyl, optionally substituted aralkyl, alkoxy, alkylthio, optionally substituted C₂-C₄₀ alkenyl, optionally substituted C₂-C₄₀ alkynyl, amino carbonyl, acylamino, acyloxy, optionally substituted aryl, aryloxy, optionally substituted amino, carboxyalkyl, optionally substituted cycloalkyl, optionally substituted cycloalkenyl, halo, acyl, optionally substituted heteroaryl, optionally substituted heteroaralkyl, heteroaryloxy, optionally substituted heterocyclyl, thiol, alkylthio, heteroarylthiol, optionally substituted sulfoxide, or optionally substituted sulfone.

8. The composition of claim 7, wherein Ar is an optionally substituted thiophene, fused thiophene, or phenyl group.

9. The composition of claim 1, wherein each Ar independently comprises one or more optionally substituted unfused thiophene groups, one or more optionally substituted fused thiophene groups, a combination of optionally substituted unfused and fused thiophene groups, or 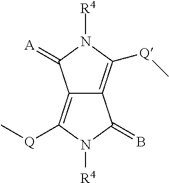
wherein X and Y are independently, a covalent bond or aryl; R₃ and R₄ are, independently, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; and, A and B are, independently, either S or O.

10. The composition of claim 1, wherein the composition comprises: 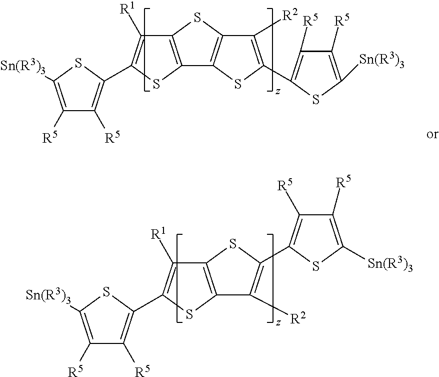
wherein z is an integer from 1 to 5; R¹ and R² are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; each R³ is, independently, hydrogen or substituted or unsubstituted C₁-C₁₀ alkyl; and each R⁵ is, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, vinyl ether, or the two R⁵'s on a single thiophene may form a optionally substituted cycloalkyl, optionally substituted heterocycloalkyl, optionally substituted aryl or optionally substituted heteroaryl.

11. A method of forming a di-tin fused thiophene monomer comprising either: 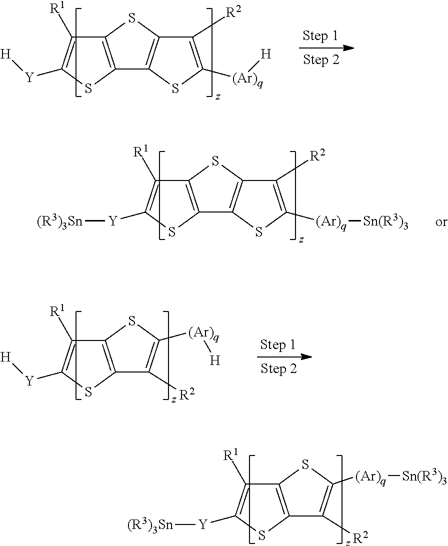
wherein z is an integer from 1 to 5; R¹ and R² are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; and each R³ is, independently, hydrogen or substituted or unsubstituted C₁-C₁₀ alkyl;
comprising:
a) deprotonation of Ar and Y and subsequently,
b) metalization of the Ar and Y groups with an alkyl tin moiety.

12. The method of claim 11, wherein the deprotonation step is done via a organolithium compound.

13. The method of claim 12, wherein the lithium compound is a butyllithium, butylmagnesium halide, or butyllithium tetramethylethylenediamine.

14. The method of claim 11, wherein the metalization step is done via a palladium catalyst.

15. The method of claim 14, wherein the palladium catalyst is metallic palladium, PdX₂, tetrakis(triphenylphosphine)palladium, or PhCH₂Pd(PPh₃)₂X, where Ph is phenyl and X is halo.

16. The method of claim 11, wherein both R₁ and R₂ are an optionally substituted alkyl group comprising at least four carbon atoms.

17. The method of claim 11, wherein Y is (Ar)_{q}.

18. The method of claim 11, wherein each Ar is independently selected from the group consisting of azoles, thiazole, benzothiophene, pyrrole, furan, or: 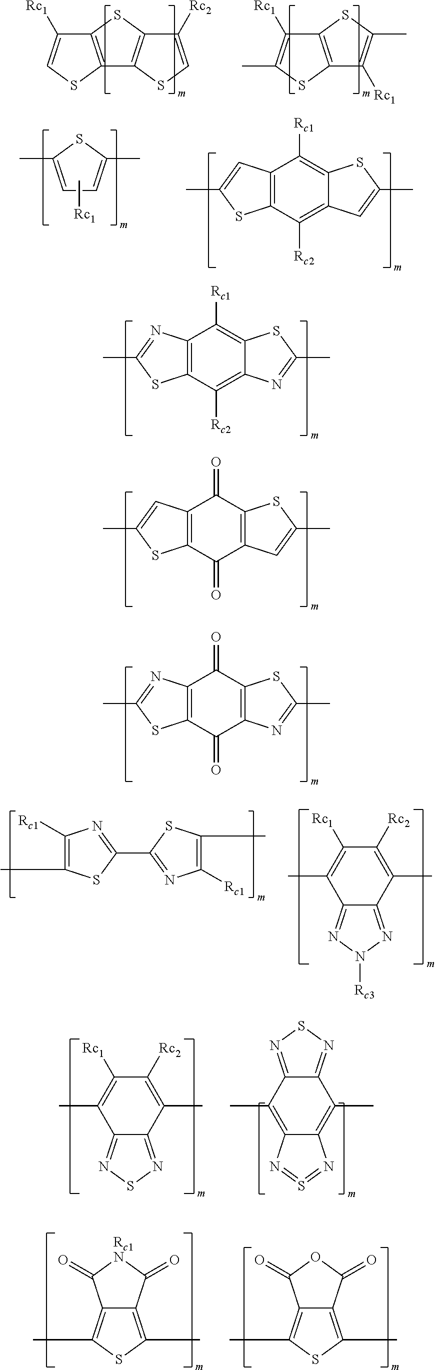 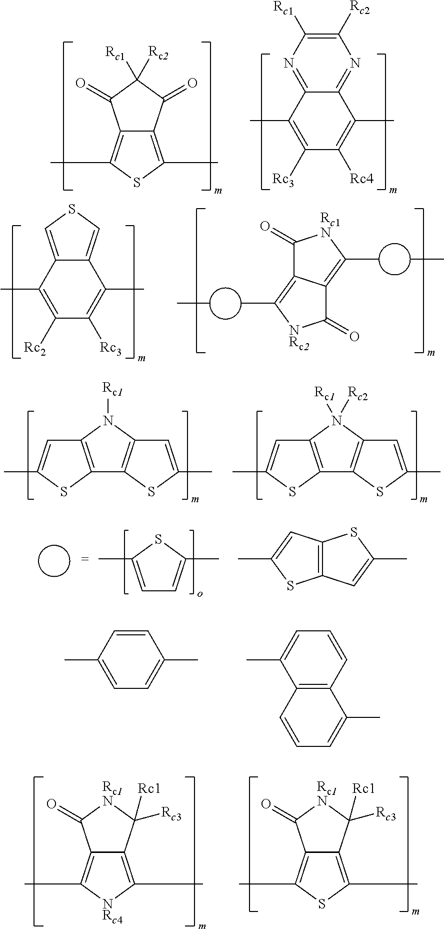
wherein each m is independently is 1, 2, or 3; o is 0, 1, 2, or 3; R_{c1}, R_{c2}, R_{c3}, and R_{c4} are independently H, halo, optionally substituted C₁-C₄₀ alkyl, optionally substituted aralkyl, alkoxy, alkylthio, optionally substituted C₂-C₄₀ alkenyl, optionally substituted C₂-C₄₀ alkynyl, amino carbonyl, acylamino, acyloxy, optionally substituted aryl, aryloxy, optionally substituted amino, carboxyalkyl, optionally substituted cycloalkyl, optionally substituted cycloalkenyl, halo, acyl, optionally substituted heteroaryl, optionally substituted heteroaralkyl, heteroaryloxy, optionally substituted heterocyclyl, thiol, alkylthio, heteroarylthiol, optionally substituted sulfoxide, or optionally substituted sulfone.

19. The method of claim 11, wherein each Ar independently comprises one or more optionally substituted unfused thiophene groups, one or more optionally substituted fused thiophene groups, a combination of optionally substituted unfused and fused thiophene groups, or 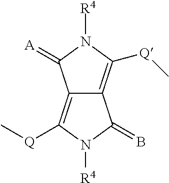
wherein X and Y are independently, a covalent bond or aryl; R₃ and R₄ are, independently, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; and, A and B are, independently, either S or O.

20. The method of claim 11, wherein the composition comprises: 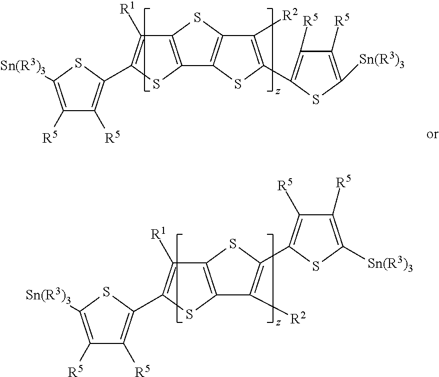
wherein z is an integer from 1 to 5; R¹ and R² are, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, or vinyl ether; each R³ is, independently, hydrogen or substituted or unsubstituted C₁-C₁₀ alkyl; and each R⁵ is, independently, hydrogen, substituted or unsubstituted alkyl, substituted or unsubstituted alkenyl, substituted or unsubstituted alkynyl, aryl, cycloalkyl, aralkyl, amino, ester, aldehyde, hydroxyl, alkoxy, thiol, thioalkyl, halide, acyl halide, acrylate, vinyl ether, or the two R⁵'s on a single thiophene may form a optionally substituted cycloalkyl, optionally substituted heterocycloalkyl, optionally substituted aryl or optionally substituted heteroaryl.
